(19) United States
(12) Patent Application Publication
(10) Pub. No.: US 2009/0106581 A1
(43) Pub. Date: Apr. 23, 2009

(54) System and method for data writing

(75) Inventors: Yoshihisa Shinogi, Saitama (JP); Makoto Yamamura, Saitama (JP); Kazuhiro Sato, Saitama (JP); Tomoki Fukushima, Saitama (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 12/286,788

(22) Filed: Oct. 2, 2008

(30) Foreign Application Priority Data
Oct. 19, 2007 (JP) 2007-272641

(51) Int. Cl. G06F 11/14; G06F 11/16

(52) U.S. Cl. 714/5; 714/54; 714/E11.113; 714/E11.054

(57) ABSTRACT

In a system for or method of data writing using a CPU and a plurality of memory banks connected to the CPU to enable the CPU to write the data thereon, a combination of data comprising data and their complement are written on a first memory bank and the same combination of data are written on a second memory bank, a sum of the combination of data written on the first and second memory banks is calculated, and when the sum of the combination of data written on one of the first and second memory banks is a specific value, it is determined that the data written on the one of the first and second memory banks are normal. With this, it becomes possible to surely determine whether the written data are normal or not, thereby enabling to enhance the data reliability.

### BACKGROUND OF THE INVENTION

1. Field of the Invention

This invention relates to a system and method for data writing, particularly to a system and method for data writing that detects whether written data are normal or abnormal.

2. Description of the Related Art

Japanese Laid-Open Patent Application No. 2003-57076 teaches a data recording system that corrects written data when they are detected to be abnormal. Specifically, the data recording system discriminates the type of abnormality when the data are determined be abnormal and records it in a predetermined record area together with the discriminated type of abnormality.

In data writing, data abnormality occurs if a trouble such as power down happens during writing. It is preferable to surely determine whether the written data are normal or normal.

### SUMMARY OF THE INVENTION

An object of this invention is therefore to solve the problem by providing a system and method for data writing that can surely determine whether the written data are normal or not.

In order to achieve the object, this invention provides at a first aspect a system for data writing having at least a CPU and a memory including a plurality of memory banks and connected to the CPU to enable the CPU to write the data on the memory, comprising: a data writer that writes a combination of data comprising data and their complement on a first memory bank of the memory, and writes same combination of data on a second memory bank of the memory; and a data determiner that calculates a sum of the combination of data written on the first and second memory banks, and when the sum of the combination of data written on one of the first and second memory banks is a specific value, determines that the data written on the one of the first and second memory banks are normal.

In order to achieve the object, this invention provides at a second aspect a method data writing having at least a CPU and a memory including a plurality of memory banks and connected to the CPU to enable the CPU to write the data on the memory, comprising the steps of: writing a combination of data comprising data and their complement on a first memory bank of the memory, and writing same combination of data on a second memory bank of the memory; calculating a sum of the combination of data written on the first and second memory banks; and determining, when the sum of the combination of data written on one of the first and second memory banks is a specific value, that the data written on the one of the first and second memory banks are normal.

### BRIEF DESCRIPTION OF THE DRAWINGS

The above and other objects and advantages of the invention will be more apparent from the following description and drawings in which:

FIG. 1 is an overall schematic block diagram of a system and method for data writing according to an embodiment of the invention taking as example a plant control system having a plant P and a controller C;

FIG. 2 is a perspective view of an outboard motor (plant P) fastened to a boat to which the plant control system shown in FIG. 1 is applied;

FIG. 3 is a block diagram showing the structure of the controller shown in FIG. 1;

FIG. 4 is an enlarged side view of the outboard motor shown in FIG. 2;

FIG. 5 is an explanatory view of memory banks in 1st and 2nd groups of an EEPROM installed in the controller shown in FIG. 1;

FIG. 6 is a flowchart showing data writing on banks in the 1st group shown in FIG. 5;

FIG. 7 is a flowchart showing data writing on banks in the 2nd group shown in FIG. 5;

FIG. 8 is a flowchart showing data normality determination on the banks in the 1st group written in the procedure of FIG. 6; and

FIG. 9 is a flowchart showing data normality determination on the banks in the 2nd group written in the procedure of FIG. 7.

### DETAILED DESCRIPTION OF THE PREFERRED EMBODIMENT

A system and method for data writing according to an embodiment of the invention will now be explained with reference to the attached drawings.

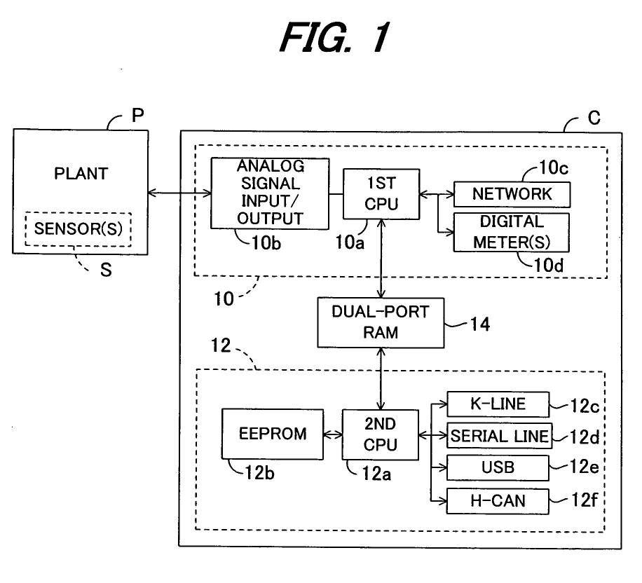

FIG. 1 is an overall schematic block diagram of a system and method for data writing according to the embodiment of the invention taking as example a plant control system.

As illustrated, the system and method for data writing according to the embodiment comprises a sensor (or sensors) S for detecting a controlled variable of a plant P and a controller C. The controller C has a 1st Electronic Control Unit (hereinafter referred to as “1st ECU) 10 that inputs the controlled variable detected by the sensor S, a 2nd Electronic Control Unit (hereinafter also referred to as “2nd ECU”) 12 and a RAM (Random Access Memory) 14.

The 1st ECU 10 has a 1st Central Processing Unit (hereinafter referred to as “1st CPU”) 10a, and the 2nd ECU 12 has a 2nd Central Processing Unit (hereinafter referred to as “2nd CPU”) 12a.

The RAM 14 comprises a dual-port RAM having a plurality of input/output ports, specifically two input/output ports, one of which is connected to the 1 st CPU 10a, while the other of which is connected to the 2nd CPU 12a.

The 1st and 2nd CPU 10a, 12a are configured to be able to asynchronously access the RAM 14, and at least one of the 1st CPU 10a and 2nd CPU 12a, specifically the 1st CPU 10a determines the manipulated variable to be supplied to the plant P.

In addition to the 1st CPU 10a, the 1st ECU 10 has an analog signal input/output 10b, a network 10c and a digital meter 10d. In addition to the 2nd CPU 12a, the 2nd ECU 12 has an EEPROM (Electrically Erasable and Programmable Read Only Memory; nonvolatile memory or memory) 12b, four communications interfaces (transmission line standard), i.e., K-line 12c, serial line (RS232C) 12d, USB 12e and H-CAN 12f. The 2nd CPU 12a accesses the RAM 14 and writes data acquired from the RAM 14 on the EEPROM 12b (explained later).

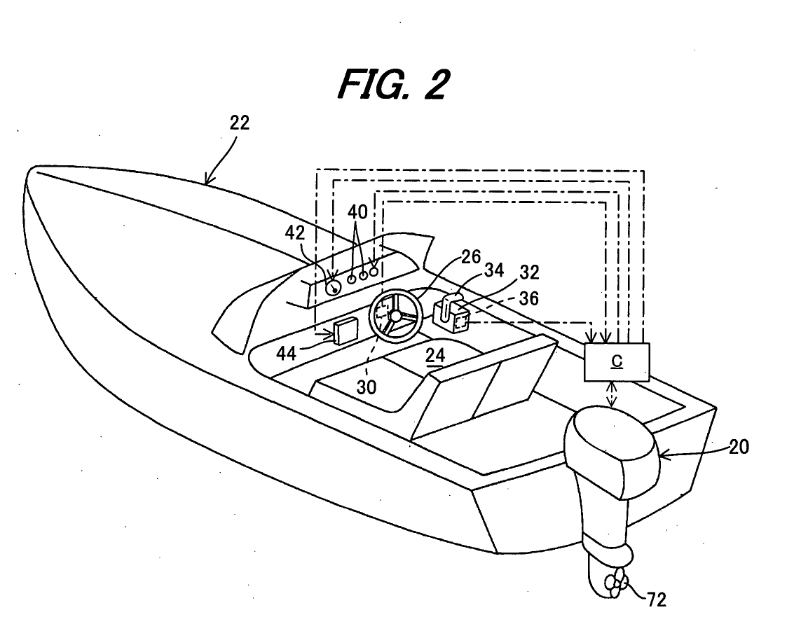

FIG. 2 is a perspective view of an outboard motor (plant P) clamped to a boat to which the plant control system shown in FIG. 1 is applied.

In FIG. 2, reference numeral 20 indicates the outboard motor. As illustrated, the outboard motor 20 is clamped to the stem or transom of the boat (hull) 22.

A steering wheel 26 is installed near a cockpit or operator's seat 24 of the boat 22. A steering wheel angle sensor 30 is installed near a rotary shaft (not shown) of the steering wheel 26 and produces an output or signal indicative of the steering angle of the steering wheel 26 manipulated by the operator.

A remote control box 32 is installed near the cockpit 24. The remote control box 32 is provided with a shift/throttle lever 34 to be manipulated by the operator. The shift/throttle lever 34 can be manipulated fore and aft from its initial position to input shift position change command and engine speed regulation command. A shift/throttle lever position sensor 36 is installed at the remote control box 32 and produces an output or signal corresponding to the position to which the shift/throttle lever 34 is manipulated by the operator.

A group of indicator lamps 40, a tachometer (analog meter) 42 and a display 44 for displaying the operating condition of the outboard motor 20, etc. are installed at the dashboard of the cockpit 24 where the steering wheel 26 is installed. The outputs of the steering wheel angle sensor 30 and shift/throttle lever position sensor 36 are sent to the controller C.

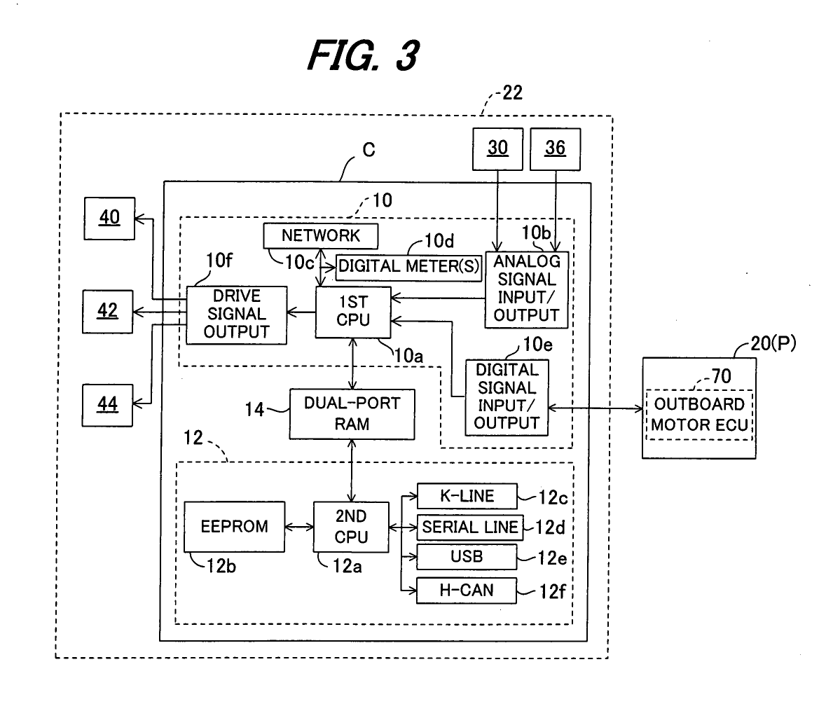

FIG. 3 is a block diagram showing the structure of the controller C. Explaining this with focus on the differences from that of FIG. 1, in addition to the 1st CPU 10a, the analog signal input/output 10b, the network 10c and the digital meter 10d, the 1st ECU 10 is equipped with a digital signal input/output 10e that inputs/outputs digital signals, and drive signal output 20f that outputs a drive signal to the indicator lamps 40, tachometer 42 and display 44 for driving them.

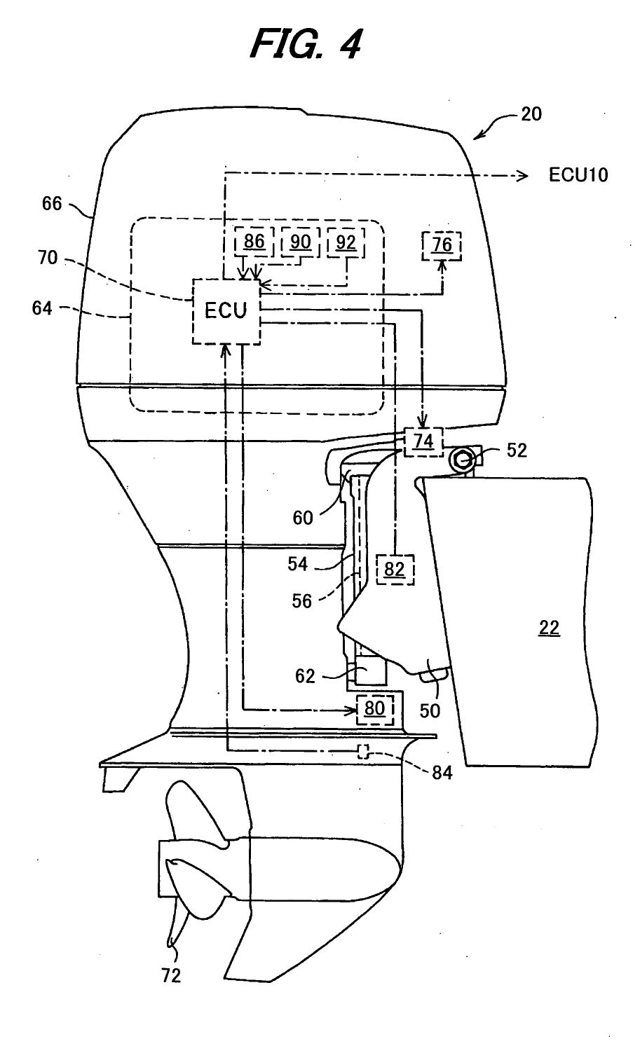

FIG. 4 is an enlarged side view of the outboard motor 20 shown in FIG. 2.

As illustrated, the outboard motor 20 is firmly fastened to the stem of the boat 22 through stern brackets 50. A swivel case 54 is attached to the stem brackets 56 through a tilting shaft 52 such that the outboard motor 20 can tilt relative to the boat 22. A swivel shaft 56 is housed in the swivel case 54 to be freely rotated about a vertical axis. The swivel shaft 56 is fixed to a mount frame 60 at its upper end and to a lower mount center housing 62 at its lower end. The mount frame 60 and lower mount center housing 62 are fixed to a frame that constitutes the main body of the outboard motor 20. With this, the operator can tilt/trim the outboard motor 20 about the tilting shaft 52 and can steer it about the swivel shaft 56.

The outboard motor 20 is equipped with an internal combustion engine (hereinafter referred to as “engine”) 64 at its upper portion. The engine 64 comprises a spark-ignition gasoline engine. The engine 64 is located above the water surface and covered by an engine cover 66.

A third Electronic Control Unit (hereinafter referred to as “outboard motor ECU”) 70 is installed beneath the engine cover 66 at a location near the engine 64.

The power of the engine 64 is transmitted downward, via a vertical shaft and a shift mechanism including a clutch (neither shown) to a propeller 72. The propeller 72 is rotated by the power transmitted from the engine 64 and produces thrust for propelling the boat 22 forward and rearward.

The outboard motor 20 is further equipped with an electric steering motor 74 for rotating the mount frame 62 about the swivel shaft 56 to steer the outboard motor 20 to the right and left directions relative to the boat 22, an electric throttle motor 76 for opening/closing a throttle valve (not shown) of the engine 64 to regulate the engine speed, an electric shift motor 80 for driving the shift mechanism to change the shift position (i.e., forward or reverse), and a power tilt/trim unit 82 having an electric motor for regulating the tilt/trim angle. A shift position sensor 84 is installed near the electric shift motor 80 and produces an output or signal indicative of the shift position.

A crank angle sensor 86 is installed near the crankshaft of the engine 64 and produces a pulse signal once per predetermined crank angular position. A manifold absolute pressure sensor 90 is installed at the intake pipe at a location downstream of the throttle valve and produces an output or signal indicative of the manifold absolute pressure, i.e., the load of the engine 64.

An engine coolant temperature sensor 92 is installed near the engine coolant passage and produces an output or signal indicative of the engine coolant temperature. Although not shown, various sensors are additionally installed and produce outputs indicative of the operating conditions of the outboard motor 20.

The outputs of the sensors are sent to the outboard motor ECU 70. The outboard motor ECU 70 counts the number of the pulse signal of the crank angle sensor 86 to detect the engine speed and controls the operation of the engine 64 based on the outputs of the sensors.

The outboard motor ECU 70 is also inputted, through the digital signal input/output 10e, with the outputs of the other sensors including the steering wheel angle sensor 30 sent from the controller C. Further, the outboard motor ECU 70 determines current command values to be supplied to the electric steering motor 74, electric throttle motor 76, electric shift motor 80 and electric motor of the power tilt/trim unit 82 based on the outputs of the sensors and controls operation of the motors. Furthermore, the outboard motor ECU 70 converts the detected engine speed and inputted sensor outputs to digital signals and outputs the converted signals.

Returning to the explanation of FIG. 3, the 1st ECU 10 inputs the outputs of the outboard motor ECU 70 through the digital'signal input/output 10e, and inputs the outputs of the steering wheel angle sensor 30 and shift/throttle lever position sensor 36 through the analog signal input/output 10b.

The 2nd CPU 12a of the 2nd ECU 12 accesses the RAM 14 to input or fetch data (the information on the outboard motor 20 which the 1st ECU 10 has acquired), and write the data on the EEPROM 12b.

The data writing of the 2nd ECU 12 on the EEPROM 12b will be explained.

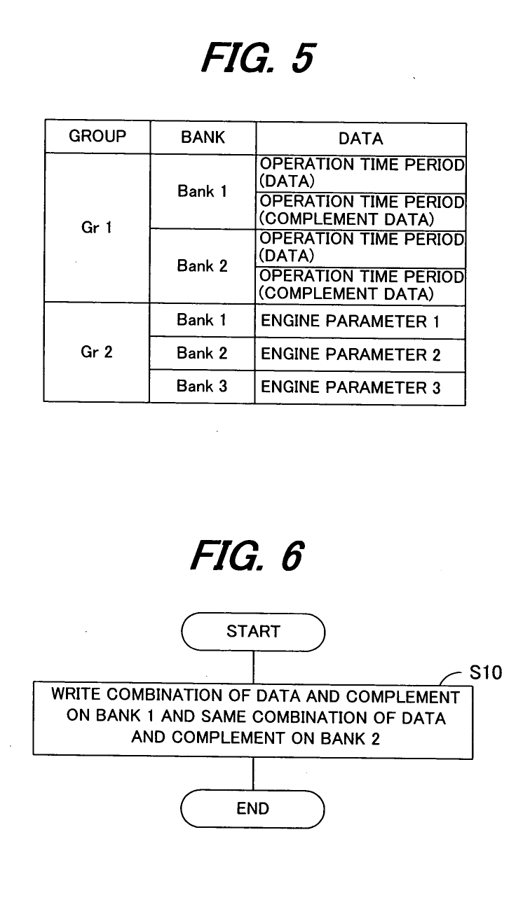

FIG. 5 is an explanatory view of memory banks in 1st and 2nd groups prepared in the EEPROM 12b. Here, the “memory bank” means a physical section of a computer memory, which may be designed to handle information transfers independently of other such transfers in other such sections. The memory bank is hereinafter referred to as “bank”.

As illustrated in FIG. 5, the EEPROM 12b has a plurality of, specifically two banks comprising Bank 1 and Bank 2 in the 1st group (Gr. 1) and three banks comprising Bank 1, Bank 2 and Bank 3 in the 2nd group (Gr. 2). On Bank 1 in Gr. 1, data on operation time period and their complement, i.e., data and their complement data are written. The same data are written on Bank 2 in the same group.

Thus, the system and method according to this embodiment has at least the 2nd CPU 12a and the EEPROM 12b connected to the CPU 12a to enable the CPU 12a to write data on the memory banks of the EEPROM 12b.

The operation time period is that of the engine 64. In the field of mathematic, the complement of a number A is another number B such that the sum A+B will produce a specific result or value. The specific result or value is ordinary 10, but in this embodiment, it is set to 0.

FIG. 6 is a flowchart showing data writing on the banks in the 1st group. The program is executed by the 2nd CPU 12a at every predetermined time. The time is predetermined taking into account the number of data writings, a service life of the engine 64, etc.

Explaining this, in S10, a combination of data comprising the data on the operation time period and their complement data are written on Bank 1 and the same combination of data, i.e., the operation time period data and their complement data are also written in Bank 2. In other words, the same combination of data are written on Bank 1, 2 at every predetermined time.

As shown in FIG. 5, on the banks in Gr. 2, data on the operating parameters of the engine 64 are written. Specifically, in Gr. 2, data on engine parameter 1 are written on Bank 1, data on engine parameter 2 are written on Bank 2 and data on engine parameter 3 are written on Bank 3. The data on engine parameter 1, engine parameter 2 and engine parameter 3 are the same value and are, for example, engine speed. Thus, the same data are written on the three banks in Gr. 2.

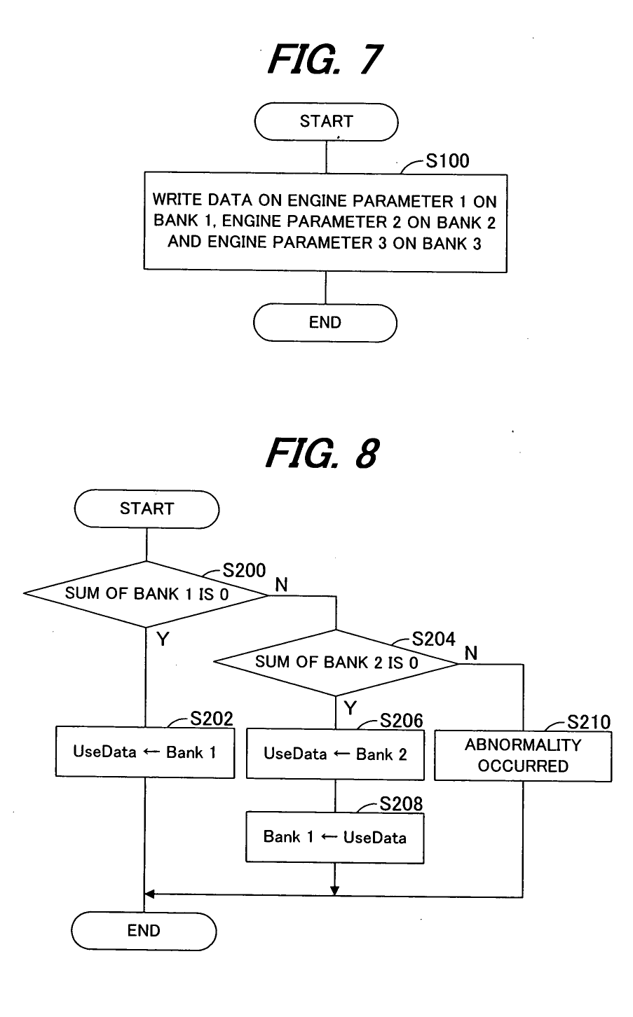

FIG. 7 is a flowchart showing data writing on the banks in the 2nd group (Gr. 2). The program is executed by the 2nd CPU 12a at irregular intervals. This is because data such as the data on the engine parameter need not be written frequently and it suffices if they are written at a time when required. In Gr. 2, the number of banks is increased by one.

Explaining this, in S100, the data on engine parameter 1 are written on Bank 1, the data on engine parameter 2 are written on Bank 2 and the data on engine parameter 3 are written on Bank 3 in Gr. 2. In other words, the same data are written on Bank 1, 2, 3 at the predetermined intervals.

The data normality determination will be explained.

FIG. 8 is a flowchart showing the data normality determination on the banks in the 1st group (Gr. 1). The program is executed by the 2nd CPU 12a at every predetermined time.

Explaining this, the sum of the combination of data written on Bank 1 is calculated in S200 to determine whether the sum is 0, i.e., the specific value. When the result is affirmative, the program proceeds to S202 in which it is determined that the data written in Bank 1, specifically the data on operation time period are normal and are the data to be used (UseData).

On the other hand, when the result in S200 is negative, the program proceeds to S204 in which the sum of the combination of data written on Bank 2 is calculated to determine whether the sum is 0. When the result is affirmative, the program proceeds to S206 in which it is determined that the data written on Bank 1 is abnormal (erroneous) and that the data written on Bank 2 are the data to be used (UseData), and to S208 in which the data to be used (data on Bank 2) are overwritten on the data on Bank 1 to correct them.

When the result in S204 is negative, the program proceeds to S210 in which it is determined that an abnormality or trouble has occurred in the EEPROM 12b.

It should be noted in the above that, it is alternatively possible to delete S204 such that, when the result in S200 is negative, the program immediately proceeds to S206 in which it is determined that the data written on 2nd Bank are normal data and to S208 in which the normal data are overwritten on the data on 1st Bank to correct them.

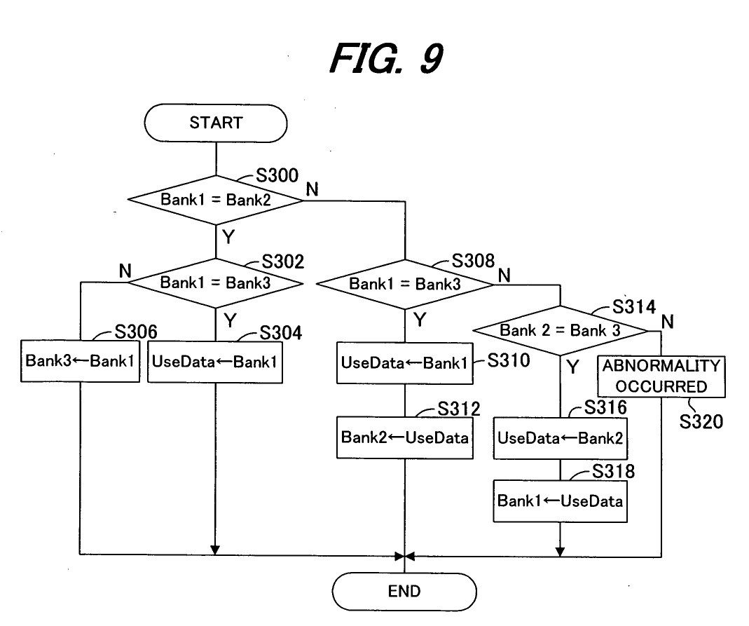

FIG. 9 is a flowchart showing the data normality determination on the banks in the 2nd group (Gr. 2). The program is executed by the 2nd CPU 12a at every predetermined time.

Explaining this, the data written on 1st Bank and the data written on 2nd Bank are compared with each other in S300 to determine whether they are identical to each other, and when the result is affirmative, the program proceeds to S302 in which the data written on 1st Bank and the data written on 3rd Bank are compared with each other to determine whether they are identical to each other.

When the result is affirmative, the program proceeds to S304 in which the data written on 1st Bank (which are determined to be identical to the data on 2nd Bank and 3rd Bank) are normal and are the data to be used (UseDate). When the result in S302 is negative, the program proceeds to S306 in which it is determined that the written on Bank 3 (which are determined to be not identical to the data on Bank 1) are abnormal or erroneous and the data written on Bank 1 are overwritten on the data on Bank 3 to correct them.

On the other hand, when the result in S300 is negative, the program proceeds to S308 in which the data written on Bank 1 and the data written on Bank 3 are compared with each other to determine whether they are identical to each other.

When the result is affirmative, the program proceeds to S310 in which it is determined that the data on Bank 1 (which are determined to be identical to the data on Bank 3) are normal and are the data to be used (UseData) and that the data written on Bank 2 are abnormal or erroneous, and to S312 in which the data to be used (data on Bank 1) are overwritten on the data on Bank 2 to correct them.

When the result in S308 is negative, the program proceeds to S314 in which the data written on Bank 2 and the data written on Bank 3 are compared with each other to determine whether they are identical to each other.

When the result is affirmative, the program proceeds to S316 in which the data on Bank 2 (which are determined be identical to the data on Bank 3) are normal and the data to be used (UseDate) and that the data written on Bank 1 are abnormal or erroneous, and to S318 in which the data to be used (data on Bank 2) are overwritten on the data on Bank 1 to correct them.

When the result in S314 is negative, the program proceeds to S320 in which it is determined that an abnormality or trouble has occurred in the EEPROM 12b.

As stated above, the embodiment is thus configured to have a system for (and method of) data writing having at least a CPU (2nd CPU 12a) and a memory (EEPROM 12b) including a plurality of memory banks (Bank 1, Bank 2) and connected to the CPU to enable the CPU to write the data on the memory, comprising: a data writer (S10) that writes a combination of data comprising data and their complement on a first memory bank (Bank 1) of the memory, and writes same combination of data on a second memory bank (Bank 2) of the memory; and a data determiner (S200 to S210) that calculates a sum of the combination of data-written on the first and second memory banks, and when the sum of the combination of data written on one of the first and second memory banks is a specific value (0), determines that the data written on the one of the first and second memory banks are normal.

With this, it becomes possible to surely determine whether the written data are normal or not, by writing the combination of data comprising data and their complement on the memory banks alternately, thereby enabling to enhance the data reliability. In addition, since it suffices if the number of memory banks is at least two, it becomes possible to shorten writing time.

The system further includes: a data corrector (S208) that determines, when the sum of the combination of data written on other of the first and second memory banks is not the specific value, the data written on the other of the first and second memory banks are abnormal, and corrects the abnormal data by overwriting the normal data thereon. With this, it becomes possible to surely correct the written data when they are determined to be abnormal or erroneous.

In the system, the data writer writes the combination of data on the first and second memory banks alternately (S10). With this, it becomes possible to enhance the chance to leave the data on the memory if a trouble such as power down happens during writing.

Further, the embodiment is thus configured to have a system for or method of data writing having at least a CPU (2nd CPU 12a) and a memory (EEPROM 12b) including a plurality of memory banks (Bank 1, Bank 2, Bank 3) and connected to the CPU to enable the CPU to write the data on the memory, comprising: a data writer (S100) that writes same data (engine parameter data) on each of the memory banks of the memory; a data determiner (S300 to S314) that compares the data written on the memory banks with each other, and when the data written on at least two memory banks are identical to each other, determines that the data determined to be identical are normal.

With this, it becomes also possible to surely determine whether the written data are normal or not, by writing the same data on the three memory banks, thereby enabling to enhance the data reliability.

The system further includes: a data corrector (S306, S312, S318) that determine, when the data written on one of the memory banks are not identical to the data written of other of the memory banks, the data determined to be not identical are abnormal, and corrects the abnormal data by overwriting the normal data thereon. With this, it becomes possible to surely correct the written data when they are determined to be abnormal or erroneous.

It should be noted in the above that, although the invention is explained taking the plant control system for the outboard motor, the invention should not be limited thereto.

It should also be noted that, although the EEPROM is used as the memory, the invention should not be limited thereto.

Japanese Patent Application No. 2007-272641 filed on Oct. 19, 2007 is incorporated herein in its entirety.

While the invention has thus been shown and described with reference to specific embodiments, it should be noted that the invention is in no way limited to the details of the described arrangements; changes and modifications may be made without departing from the scope of the appended claims.

What is claimed is:

1. A system for data writing having at least a CPU and a memory including a plurality of memory banks and connected to the CPU to enable the CPU to write the data on the memory, comprising:
a data writer that writes a combination of data comprising data and their complement on a first memory bank of the memory, and writes same combination of data on a second memory bank of the memory; and
a data determiner that calculates a sum of the combination of data written on the first and second memory banks, and when the sum of the combination of data written on one of the first and second memory banks is a specific value, determines that the data written on the one of the first and second memory banks are normal.

2. The system according to claim 1, further including:
a data corrector that determines, when the sum of the combination of data written on other of the first and second memory banks is not the specific value, the data written on the other of the first and second memory banks are abnormal, and corrects the abnormal data by overwriting the normal data thereon.

3. The system according to claim 1, wherein the data writer writes the combination of data on the first and second memory banks alternately.

4. A system for data writing having at least a CPU and a memory including a plurality of memory banks and connected to the CPU to enable the CPU to write the data on the memory, comprising:
a data writer that writes same data on each of the memory banks of the memory;
a data determiner that compares the data written on the memory banks with each other, and when the data written on at least two memory banks are identical to each other, determines that the data determined to be identical are normal.

5. The system according to claim 4, further including:
a data corrector that determine, when the data written on one of the memory banks are not identical to the data written of other of the memory banks, the data determined to be not identical are abnormal, and corrects the abnormal data by overwriting the normal data thereon.

6. A method of data writing having at least a CPU and a memory including a plurality of memory banks and connected to the CPU to enable the CPU to write the data on the memory, comprising the steps of:
writing a combination of data comprising data and their complement on a first memory bank of the memory, and writing same combination of data on a second memory bank of the memory;
calculating a sum of the combination of data written on the first and second memory banks; and
determining, when the sum of the combination of data written on one of the first and second memory banks is a specific value, that the data written on the one of the first and second memory banks are normal.

7. The method according to claim 6, further including the steps of:
determining, when the sum of the combination of data written on other of the first and second memory banks is not the specific value, the data written on the other of the first and second memory banks are abnormal; and
correcting the abnormal data by overwriting the normal data thereon.

8. The method according to claim 6, wherein the step of data writing writes the combination of data at every predetermined time.

9. A method of data writing having at least a CPU and a memory including a plurality of memory banks and connected to the CPU to enable the CPU to write the data on the memory, comprising the steps of:
writing same data on each of the memory banks of the memory;
comparing the data written on the memory banks with each other; and
determining, when the data written on at least two memory banks are identical to each other, that the data determined to be identical are normal.

10. The method according to claim 9, further including the steps of:
determining, when the data written on one of the memory banks are not identical to the data written of other of the memory banks, the data determined to be not identical are abnormal; and
correcting the abnormal data by overwriting the normal data thereon.
